(19) United States
(12) Patent Application Publication
(10) Pub. No.: US 2014/0255587 A1
(43) Pub. Date: Sep. 11, 2014

(54) NOVEL HOP POWDERS

(71) Applicant: S.S. Steiner, Inc., New York, NY (US)

(72) Inventors: Jeremy Leker, Yakima, WA (US); Robert Smith, Yakima, WA (US); John Paul Maye, Great Falls, VA (US); Adam Gimbel, Atlantic Highlands, NY (US); Harald Schwarz, Seattle, WA (US)

(73) Assignee: S.S. Steiner, Inc., New York, NY (US)

(21) Appl. No.: 14/198,196

(22) Filed: Mar. 5, 2014

Related U.S. Application Data
(60) Provisional application No. 61/776,550, filed on Mar. 11, 2013.

(51) Int. Cl. C12C 3/06

(52) U.S. Cl. CPC C12C 3/06
USPC 426/600

(57) ABSTRACT

The present invention is an extracted hop powder which has one or more hop acids blended back. This hop acid powder is flowable, does not cake-up and is more stable than hop powder that has not been extracted.

### CROSS-REFERENCE TO RELATED APPLICATIONS

This application claims priority from U.S. Provisional Application Ser. No. 61/776,550 filed Mar. 11, 2013, the contents of which are incorporated herein by reference.

### STATEMENT REGARDING FEDERALLY SPONSORED RESEARCH OR DEVELOPMENT

Not applicable.

### TECHNICAL FIELD

### Background of the Invention

The present invention relates to producing flowable, non-sticky, stable hop powders. Hops have a long history of use as a flavor agent and preservative in beer. Hop flowers contain high concentrations of organic acids, polyphenols, essential oils, waxes and fats, cooperatively known as hop resin. Hop resin can make-up as much as 30% to 40% by weight of the dried hop flower and this resin is known for its stickiness. Hop resin is readily extracted with solvents such as liquid or supercritical carbon dioxide. The organic acids within hops, Humulone (also known as alpha acids) and Lupulone (also known as beta acids), are known for their strong antibacterial properties and can selectively inhibit gram positive bacteria growth. When hops are boiled in the brew kettle the alpha acids within the hops thermally isomerize to form isoalpha acids. Isoalpha acids give beer its bitter flavor, however, they are not light stable. That is, when beer is packaged in clear or green bottles, the isoalpha acids can react with visible light and in presence of riboflavin and natural sulfur compounds in beer form the mercaptan 3-methyl-2-butene-1-thiol. This mercaptan has a strong skunky like aroma and is detectable in beer at the ppb level. To make light stable hop acids, hops are extracted, the alpha acids isolated and isomerized and the resulting isoalpha acids reduced with sodium borohydride or catalytic palladium on carbon with hydrogenation gas or both. Like Humulone and Lupulone, isomerized and reduced hop acids are also antibacterial. Hops and hop acids are finding new uses, for example as natural antibacterial for the production of fuel ethanol, spirits, yeast and animal feed. The incorporation of hop acids into animal feed can be problematic if the hop acids are not homogeneously distributed throughout the feed. In order to be effective, it is important that the animal gets a consistent dosing of the hop acid with every “bite” of feed. Raw hop powder can readily perform this task; however, due to the very high resin content hop powder is very sticky. This stickiness causes hop powder to clump, making the handling and dosing, particularly through automatic dosing systems nearly impossible. This clumping of the hop powder causes serious problems at feed mills and feed manufacturers as it does not permit a consistent dosing and production of a feed with a homogenous concentration of the active ingredient. As a result, there is a real need to produce a hop powder that is not sticky and does not clump.

### SUMMARY OF THE INVENTION

We discovered that if one extracts hops with a solvent such as liquid or super critical CO2 gas one can remove most of the hop resin producing a non-sticky hop powder we call PPP. By blending back individual hop acids to PPP one can make a free flowing powder that does not brick-up when packaged or cake-up when added via an automatic dosing systems at feed mills.

### DETAILED DESCRIPTION OF THE INVENTION

Dry hop flowers are ground into a powder, pelletized and extracted with super critical carbon dioxide. The Humulone and Lupulone of the resulting CO2 hop extract can be separated using aqueous alkaline pH partitioning techniques commonly used in the hop industry. The Humulone can be isomerized to produce isoalpha acids and or further reduced using sodium borohydride or palladium on carbon catalyzed hydrogen reduction or both to produce rho-isoalpha acids, tetrahydro-isoalpha acids, and hexahydro-isoalpha acids respectively. Alternatively, the Humulone of the the CO₂ extract can first be isomerized to isoalpha acids as described in U.S. Pat. No. 5,370,847, followed by separation of the isoalpha acids from the beta acid (Lupulone) hop oil fraction. Humulone, Lupulone, isoalpha acids, rho-isoalpha acids, tetrahydro-isoalpha acids, and hexahydro-isoalpha acids can individually or in combination blended with PPP at concentrations less than 40% w/w, preferably less than 20% w/w, more preferably less than 12% w/w to produce non-sticky hop powders.

Using a vertical blend mixer, plough share mixer or the like, PPP is added and while mixing, the concentrated hop acid is slowly added until the desired concentration is achieved. After sufficient time of mixing to insure homogeneity the hop powder is packaged.

In a preferred embodiment, the hop acid comprises an alpha acid, a beta acid, an isoalpha acid, a rho-isoalpha acid, a tetrahydro-isoalpha acid, and a hexahydro-isoalpha acid or a hexahydro-beta acid.

In another and preferred embodiment of the invention, the hop powder is pelletized following the teachings of, e.g., U.S. Pat. No. 4,123,561, the contents of which is incorporated herein by reference.

For clarity of disclosure, and not by way of limitation, the detailed description of the invention is divided into the subsections set forth below.

### EXAMPLES

### 1. How to Produce 10% Alpha Acids PPP

Two kilograms of CO2 hop extract containing 50% w/w alpha acids is added to 10-kg of water at 60° C. and one equivalent of potassium hydroxide solution, based on alpha acid concentration, is added to make a potassium salt of alpha acids. The aqueous layer, containing the potassium salt of alpha acids is separated from the beta acid hop oil fraction and acidified with 50% sulfuric acid in a separate vessel to a pH less than 3.0. The resulting alpha acid resin is isolated from the water layer and blended with approximately 9-kg of PPP in a vertical blend mixer and mixed until a 10% w/w hop powder is formed. The resulting product is a free-flowing, non-sticky powder.

### 2. How to Produce a Beta Acid PPP

The beta acid hop oil fraction from above was isolated and mixed with 8-kg PPP in a vertical blend mixer and mixed until a 8% w/w beta acid concentration was obtained. Alternatively, one can take the beta acid hop oil fraction from above, add it to a vessel contain 10-kg of 60° C. water and one equivalent of potassium hydroxide and mix to form the water soluble potassium salt of beta acids. This aqueous beta acid layer is then sent to a separate vessel and acidified with 50% sulfuric acid to a pH less than 5 to obtain a water layer and beta acid resin layer. The beta acid resin layer can be combined with 6-kg of PPP and mixed in a vertical blend mixer to obtain 10% beta acids PPP. The resulting product is a free-flowing, non-sticky powder.

### 3. How to Make Beta Acid Hop Oil PPP

A beta acids-hop oil resin (50% beta acids) was obtained from aqueous extraction of isomerized kettle extract made from CO₂ extract of hops by method described in U.S. Pat. No. 5,370,847. 260 g of this hot, beta acids-hop oil resin was slowly poured onto 1.0 kg of warm PPP while being mixed. After mixing for a few minutes, a flowable hop powder was obtained and it consisted of 10.5% beta acids (theoretical was 10.4% beta acids). The resulting product is a free-flowing, non-sticky powder.

### 4. How to Make 10% Isoalpha Acids PPP

Commercially available 30% isoalpha acids is warmed to 60° C. and acidified with 50% sulfuric acid to a pH of less than 3.0. The water layer is separated from the isoalpha acid resin layer. This resin layer is mixed with 9 times its weight of PPP and mixed in a vertical blender until homogenous to obtain a 10% isoalpha acid PPP powder. The resulting product is a free-flowing, non-sticky powder.

### 5. How to Make 10% Rho-Isoalpha Acids PPP

Commercially available 30% Rho-isoalpha acids is warmed to 60° C. and acidified with 50% sulfuric acid to a pH of less than 3.0. The water layer is separated from the rho-isoalpha acid resin layer. This resin layer is mixed with 9 times its weight of PPP and mixed in a vertical blender until homogenous to obtain a 10% Rho-isoalpha acid PPP powder. The resulting product is a free-flowing, non-sticky powder.

### 6. How to Make 10% Tetra-Isoalpha Acids PPP

Commercially available 10% Tetrahydro-isoalpha acids is warmed to 60° C. and acidified with 50% sulfuric acid to a pH of less than 3.0. The water layer is separated from the Tetrahydro-isoalpha acid resin layer. This resin layer is mixed with 9 times its weight of PPP and mixed in a vertical blender until homogenous to obtain a 10% Tetrahydro-isoalpha acid PPP powder. The resulting product is a free-flowing, non-sticky powder.

### 7. How to Make 10% Hexahydro-Isoalpha Acids PPP

Commercially available 10% Hexahydro-isoalpha acids is warmed to 60° C. and acidified with 50% sulfuric acid to a pH of less than 3.0 The water layer is separated from the isoalpha acid resin layer. This resin layer is mixed with 9 times its weight of PPP and mixed in a vertical blender until homogenous to obtain a 10% hexahydro-isoalpha acid PPP powder. The resulting product is a free-flowing, non-sticky powder.

It is thus seen the present invention provides a useful hop acid powder that is non-sticky, flowable and does not cake-up. Moreover, unexpectedly, we observed improved stability of Beta Acids+PPP vs Hop Powder containing all the hop resin components. The extracted hop powder/hop acid blend in accordance with the present invention also is observed to be more stable than raw hop powder or hop acids combined with conventional used carriers such as SiO2, malto-dextrin, cellulose or other commonly used carriers.

Various changes may be made in the above description without departing from the spirit and scope of the invention.

What is claimed is:

1. A free-flowing, non-sticky extracted hop powder which contains one or more hop acids blended back.

2. The hop powder of claim 1, wherein the hop acid comprises an alpha acid.

3. The hop powder of claim 1, wherein the hop acid comprises a beta acid.

4. The hop powder of claim 1, wherein the hop acid comprises an isoalpha acid.

5. The hop powder of claim 1, wherein the hop acid comprises a rho-isoalpha acid.

6. The hop powder of claim 1, wherein the hop acid comprises a tetrahydro-isoalpha acid.

7. The hop powder of claim 1, wherein the hop acid comprises a hexahydro-isoalpha acid.

8. The hop powder of claim 1, wherein the hop acid comprises a hexahydro-beta acid.

9. The hop powder of claim 1, wherein the hop acid comprises a mixture of more than one hop acid selected from the group consisting of an alpha acid, a beta acid, an isoalpha acid, a rho-isoalpha acid, a tetrahydro-isoalpha acid, a hexahydro-isoalpha acid, and a hexahydro-beta acid.

10. The hop powder of claim 1, wherein the concentration of the hop acid is less than 20% w/w.

11. The hop powder of claim 1, wherein the concentration of the hop acid is less than 12% w/w.

12. The hop powder of claim 1, wherein the hop acid comprises a salt of a hop acid.

13. The hop powder of claim 1, further containing a flow aid to enhance flowability.

14. The hop powder of claim 1, wherein the hop acid is in propylene glycol prior to mixing with the extracted hop powder.

15. The hop powder of claim 1, further containing hop oil.

16. The hop powder of claim 1, in pelletized form.

17. An extracted hop powder and hop acid blend, characterized by being more stable than raw hop powder or hop acids combined with SiO2, malto-dextrin, cellulose or other commonly used carriers.
